(19) United States
(12) Patent Application Publication
(10) Pub. No.: US 2024/0292065 A1
(43) Pub. Date: Aug. 29, 2024

(54) DEVICE, METHOD, SYSTEM AND PROGRAM FOR VIDEO TRANSMISSION ACCORDING TO APPLICATION STATUS

(71) Applicant: NIPPON TELEGRAPH AND TELEPHONE CORPORATION, Tokyo (JP)

(72) Inventors: Tatsuya FUKUI, Musashino-shi, Tokyo (JP); Toshihito FUJIWARA, Musashino-shi, Tokyo (JP); Ryota SHIINA, Musashino-shi, Tokyo (JP); Hiroya ONO, Musashino-shi, Tokyo (JP)

(73) Assignee: NIPPON TELEGRAPH AND TELEPHONE CORPORATION, Tokyo (JP)

(21) Appl. No.: 18/564,541

(22) PCT Filed: Jun. 21, 2021
(86) PCT No.: PCT/JP2021/023425

§ 371 Date: Nov. 27, 2023

(51) Int. Cl. H04N 21/6371; H04N 21/6379

(52) U.S. Cl. CPC H04N 21/6371; H04N 21/6379

(57) ABSTRACT

An object of the present disclosure is to enable low-delay video transmission in applications requiring video transmission with low delay even when the network is congested.

The present disclosure relates to a device which acquires a status of an application using video transmission; selects an encoding scheme and a decoding scheme of a video signal generated by the application according to the status of the application; and secures resources of a data transmission network that transmits the video signal according to the selection result.

### TECHNICAL FIELD

The present disclosure relates to a technology for transmitting video signals through a data transmission network.

### BACKGROUND ART

With the spread of 5G/IoT, the spread of remote robot operations and cloud games is progressing. In these systems, it is necessary to perform video transmission with low delay. In order to perform low-delay video transmission, it is necessary to adopt an encoding scheme with a low compression ratio or an uncompressed encoding scheme and to reduce a size of a buffer provided on the receiver side.

Using less-compressed or uncompressed encoding schemes will require more bandwidth. Furthermore, in order to reduce the size of the buffer provided on the receiving side, a data transmission network with suppressed delay variation is required. Therefore, the number of video flows that can perform low-latency video transmission may be limited.

Delay requirements required for video transmission differ depending on the status of an application. For example, in a cloud versus fighting game running at 60 fps (frames per second), a delay of about 16.6 ms occurring in video transmission may not be detectable by the user. On the other hand, in a game such as a first-person shooter (FPS) running at 120 fps, a delay of only about 8.3 ms may be detected.

Further, in the case of robot operation, robots are often automatically run for routine work. In such cases, even if the video transmission delay is about 100 ms, it will not be a problem. On the other hand, in the case of non-routine works, since the operation is manually performed by a person, a smaller delay will be better.

With the spread of 5G and optical communication lines, video transmissions to remote locations, such as virtual meetings, cloud games, and remote robot operations, are becoming widespread. When transmitting video to a remote location, it is common to adopt a configuration in which encoding and decoding are performed by computers or smartphones at both ends.

On the other hand, if a device interface (IF) direct receiving network configuration is used in which a video device IF is directly accommodated in a data transmission network and transmitted, there is no need to place computers for encoding/decoding at both ends. Therefore, reduction in the number of devices to be prepared by the user and power saving can be expected. In this case, resources in the data transmission network are finite, so encoding/decoding must be properly performed within the data transmission network.

The delay requirements required for video transmission differ depending on the status of the application. For example, in robot operation, there is no problem even if the video transmission delay is long when the robot is stopped, but the delay must be low during operation. In a case where cloud games transmit game videos, it can be considered that the allowable video transmission delay differs depending on the type of game. For example, a solitaire game may have a large delay, but an FPS requires a low delay.

NPL 1 proposes a technique of estimating the congestion status of a data transmission network and automatically changing the band setting of the encoder. By using this technology, in a case where there is vacancy in the data transmission network, the encoder bandwidth can be increased for low-delay transmission, and in a case where the data transmission network is congested, the encoder bandwidth can be decreased for non-low-delay transmission.

In NPL 1, the application status is not considered, and low-delay video transmission may not be possible in applications requiring low-delay video transmission. Specifically, when the data transmission network becomes congested, and there are an application requiring low-delay transmission and an application that does not require low-delay transmission, operation that gives priority to the low-delay side and increases the encoding band is not available.

### CITATION LIST

### Non Patent Literature

[NPL 1] Stable 4K Video Transmission over Various Lines such as the Internet-“High-Quality, Low-Delay Encoder & Decoder” by Haivision https://www.rikei.co.jp/mail-magazine/pickup/16.html

### SUMMARY OF INVENTION

### Technical Problem

An object of the present disclosure is to enable low-delay video transmission in applications requiring video transmission with low delay even when a data transmission network is congested.

### Solution to Problem

A device and a method according to the present disclosure are respectively capable of acquiring status of an application using video transmission; selecting an encoding scheme and a decoding scheme of a video signal generated by the application according to the status of the application; and securing resources of a data transmission network that transmits the video signal according to the selection result.

A device according to the present disclosure can also be implemented by a computer and a program, and the program can be recorded in a recording medium or can also be provided via a network.

A system according to the present disclosure is a system including:
a video signal source that executes an application that uses video transmission;
a data transmission network that transmits a video signal generated by the application; and
a controller that controls resources of the data transmission network, wherein the controller is configured to:
acquire a status of the application from the video signal source;
select an encoding scheme and a decoding scheme of a video signal generated by the application according to the acquired status of the application; and secure resources of a data transmission network according to the selection result.

### Advantageous Effects of Invention

According to the present disclosure, it is possible to enable low-delay video transmission in applications requiring video transmission with low delay even when the data transmission network is congested.

### BRIEF DESCRIPTION OF DRAWINGS

FIG. 1 is a diagram illustrating a system configuration example of the present disclosure.

FIG. 2 is a diagram illustrating a system configuration example according to the present embodiment.

FIG. 3 shows a configuration example of a video MC.

FIG. 4 shows an example of a rule table referred to by a controller 94.

FIG. 5 shows an example of system operation when an application is halted.

FIG. 6 shows an example of system operation when the application is in operation.

FIG. 7 shows an operation example of the system when the application is a solitaire game.

FIG. 8 shows an operation example of the system when the application is an FPS.

FIG. 9 is a diagram illustrating a system configuration example according to the present embodiment.

FIG. 10 shows a configuration example of a video MC.

FIG. 11 shows an example of system operation when an application is halted.

FIG. 12 shows an example of system operation when the application is in operation.

FIG. 13 shows an operation example of the system when the application is a solitaire game.

FIG. 14 shows an operation example of the system when the application is an FPS.

FIG. 15 is a diagram illustrating a system configuration example according to the present embodiment.

FIG. 16 shows a configuration example of an access MC.

### DESCRIPTION OF EMBODIMENTS

Embodiments of the present disclosure will be described hereinafter in detail with reference to the drawings. It is to be understood that the present disclosure is not limited to the embodiments described below. The embodiments are merely exemplary and the present disclosure can be implemented in various modified and improved modes based on knowledge of those skilled in the art. Constituent elements with the same reference signs in the present specification and in the drawings represent the same constituent elements.

### (System Configuration)

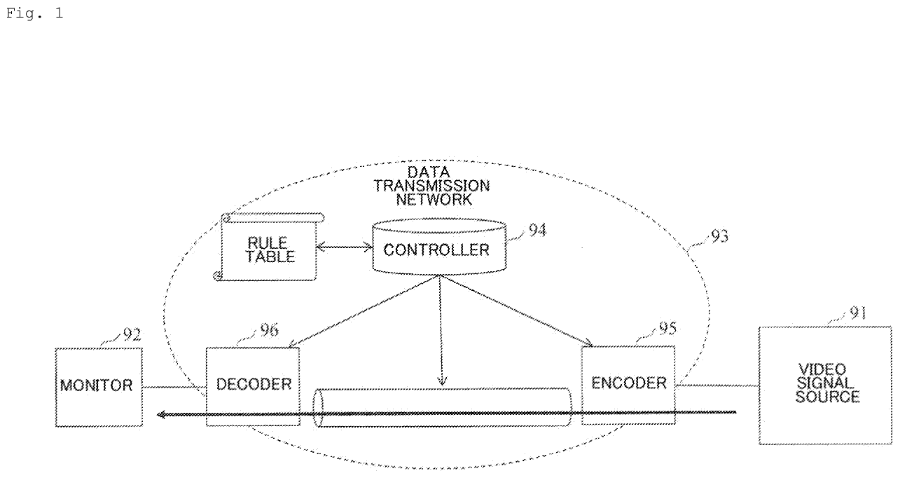

FIG. 1 illustrates an example of a system configuration according to the present disclosure. The system of the present disclosure is a system in which a video signal source 91 and a monitor 92 are connected via a data transmission network 93. The video signal source 91 is a device that executes an application using video transmission. The monitor 92 displays a video signal generated by the video signal source 91.

The system of the present disclosure includes a controller 94 that controls signals transmitted over the data transmission network 93. Specifically, the system of the present disclosure includes an encoder 95 between the data transmission network 93 and the video signal source 91 and a decoder 96 between the data transmission network 93 and the monitor 92. The encoder 95 encodes the video signal from video signal source 91. The encoded video signal is converted into a format that can be transmitted over a data transmission network and transmitted to the decoder 96 via the data transmission network 93. The decoder 96 decodes the video signal transmitted over the data transmission network 93.

The video signal source 91 notifies the controller 94 within the network of status of its own application (hereinafter sometimes referred to as “application status”). The controller 94 performs the following control according to predetermined rules based on the status of the video signal source 91 notified from the video signal source 91.
(1) Encoding and coding schemes used by the encoder 95 and the decoder 96;
(2) Setting of network paths used in the data transmission network 93.

Therefore, the present disclosure enables the operation of securing resources such that the encoding bandwidth becomes larger with priority given to the low delay side, and also low-delay video transmission in applications requiring video transmission with low delay even when the data transmission network 93 is congested.

### First Embodiment

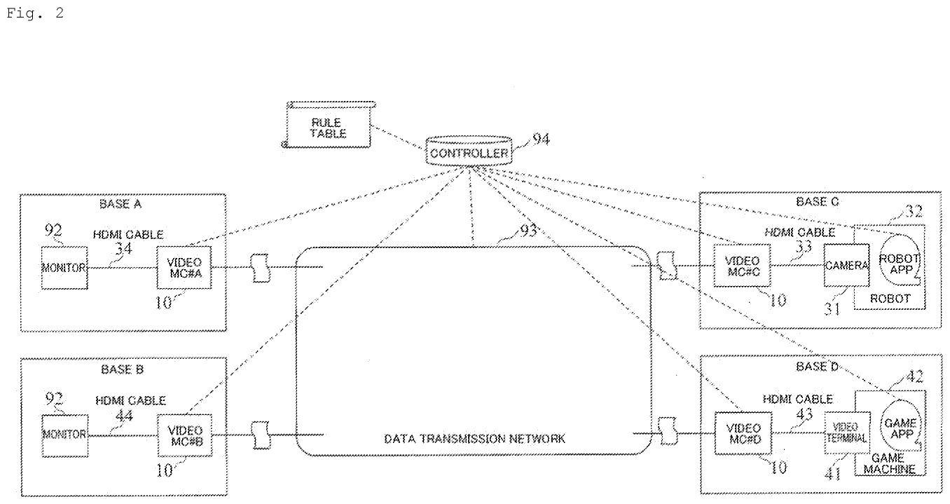

FIG. 2 illustrates a configuration example of a system according to the present embodiment. In the video transmission system according to the present embodiment, the monitors 92 located at bases A and B are connected to the data transmission network 93, a robot 32 located at a base C is connected to the data transmission network 93, and a game machine 42 located at D is connected to the data transmission network 93.

The data transmission network 93 is a communication network capable of providing connections over multiple network paths such as wavelength paths and band paths. The wavelength path is a configuration in which ends are connected to each other via a line of a specific wavelength using, for example, WDM (Wavelength Division Multiplexing) or an optical switch. The band path is a configuration in which ends are connected to each other via a logical path of any band (e.g. 100 Mbps) using, for example, MPLS (Multi-Protocol Label Switching).

The robot 32 has a camera 31, and a video signal captured by the camera 31 is output to a video MC (media converter) 10 #C through an HDMI cable 33. The game machine 42 has a video terminal 41, and a video signal of the game machine 42 is output to a video MC 10 #D through an HDMI (registered trademark) cable 43 connected to the video terminal 41. The video MC 10 having the encoder 95 and the decoder 96 is provided between the video signal source 91 (such as the robot 32 and the game machine 42) and the data transmission network 93, and between the monitor 92 and the data transmission network 93.

An application using video transmission provided in the robot 32 and the game machine 42 notifies the controller 94 of its own status. When the controller 94 is notified of the current application status from the applications of the robot 32 and the game machine 42, it refers to the rule table and controls the operation of the video MC 10 according to the description, and provides the necessary network paths (bandwidth paths, wavelength paths, etc.) within the data transmission network 93.

In the case of the robot 32, it is controlled by the operating status of the robot 32 (stopping or moving).

In the case of the game machine 42, it is controlled according to the type of game.

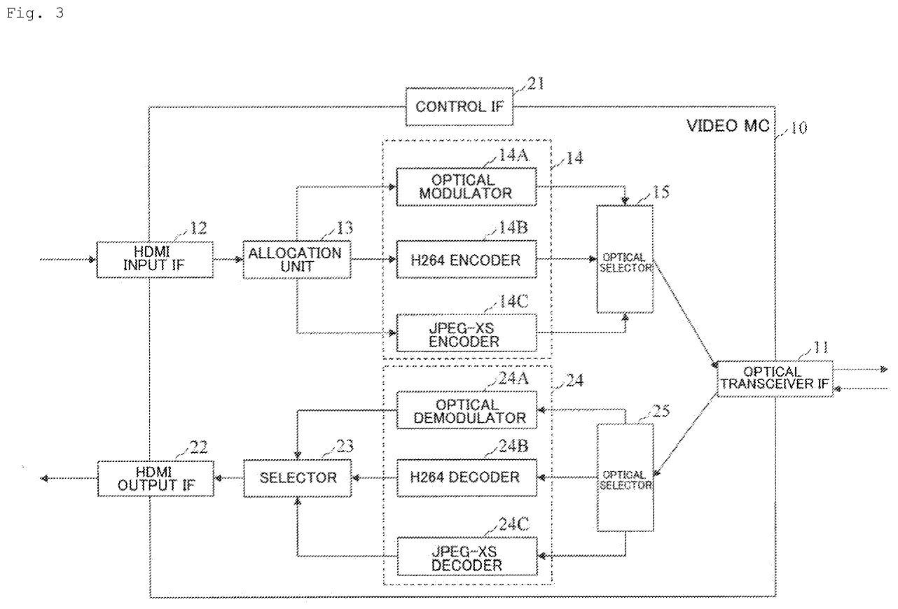

FIG. 3 shows a configuration example of a video MC 10.

The video MC 10 has a function of encoding a video signal and converting it into a format that can be transmitted over the data transmission network 93. Specifically, the video MC 10 includes an HDMI input IF 12, an allocation unit 13, an encoder 14, an optical selector 15, and an optical transceiver IF 11.

The video MC 10 has a function of decoding the video signal transmitted over the data transmission network 93 and returning it to the video signal from the video signal source 91. Specifically, the video MC 10 includes an optical transceiver IF 11, an optical selector 25, a decoder 24, a selector 23, and an HDMI output IF 22.

The encoder 14 functions as the encoder 95 and performs any encoding available in the video transmission system. For example, the encoder 14 includes an optical modulator 14A, an H264 encoder 14B, and a JPEG-XS encoder 14C. The optical modulator 14A performs optical image modulation by modulating the HDMI signal as it is into an optical signal without compressing the video signal. The H264 encoder 14B H264-encodes the HDMI signal and modulates it into an optical signal. The JPEG-XS encoder 14C JPEG-XS-encodes the HDMI signal and modulates it into an optical signal. The controller 94 controls operations of the allocation unit 13 and the optical selector 15 from the control IF 21.

The decoder 24 functions as the decoder 96 and performs any decoding available in the video transmission system. For example, the decoder 24 includes an optical demodulator 24A, an H264 decoder 24B, and a JPEG-XS decoder 24C. The optical demodulator 24A demodulates the optical signal into an electrical signal. Thus, the signal generated by the optical modulator 14A can be decoded into an HDMI signal. The H264 decoder 24B demodulates the optical signal and decodes the signal encoded by the H264 encoder 14B into an HDMI signal. The JPEG-XS decoder 24C demodulates the optical signal and decodes the signal encoded by the JPEG-XS encoder 14C into an HDMI signal. The controller 94 controls operations of the optical selector 25 and the selector 23 from the control IF 21.

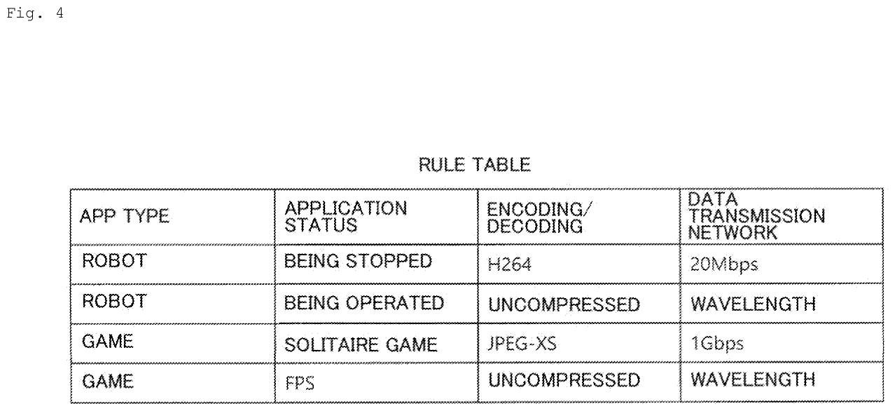

FIG. 4 shows an example of a rule table referred to by the controller 94. The rule table defines, for each application type, the type of encoding and decoding schemes and the type of network path according to the application status. In the case of low-delay applications, uncompressed or low-compression encoding and decoding schemes are selected, and in the case of non-low-delay applications, high-compression encoding and decoding schemes are selected. Resources of the data transmission network 93 allocated to low-delay applications are larger than resources of the data transmission network 93 allocated to non-low-delay applications. In the present embodiment, uncompressed optical modulation, low-compression JPEG-XS, and high-compression H264 are exemplified as examples of encoding and decoding schemes. Low compression refers to a low-delay compression method that does not significantly reduce the bandwidth. High compression means a compression scheme with a large delay but a large reduction in bandwidth. The uncompressed, high-compressed, and low-compressed encoding and decoding schemes of the present disclosure are not limited thereto.

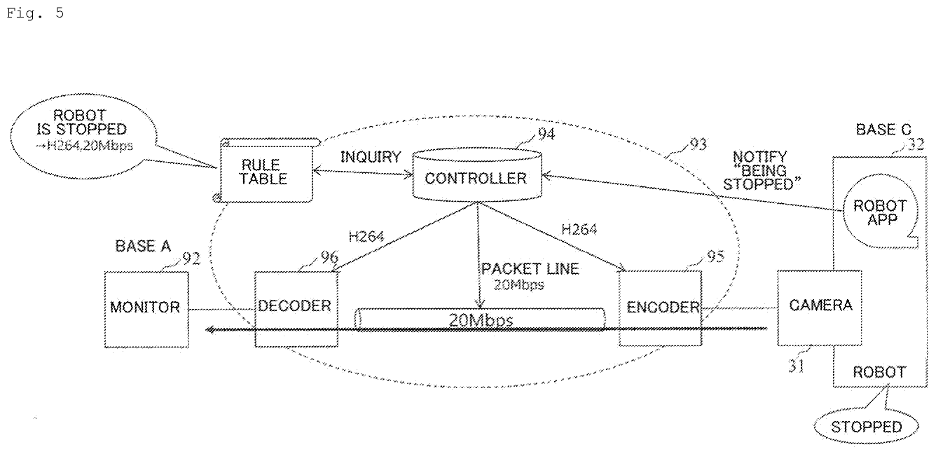

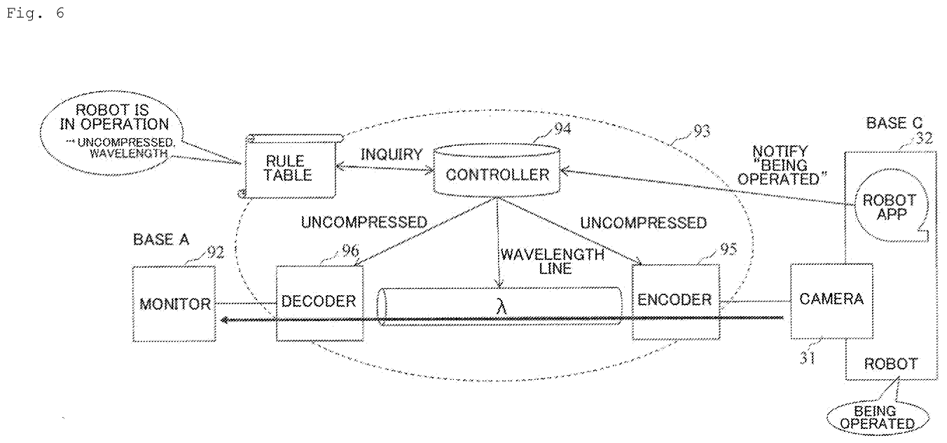

An example of system operation when displaying a video from the robot 32 at the base C on the monitor 92 at the base A will be described with reference to FIGS. 5 and 6. FIG. 5 shows the case where the robot 32 is stopped, and FIG. 6 shows the case where the robot 32 is in operation. In the rule table, as shown in FIG. 4, in a case where the robot 32 is stopped, it is assumed that the application is a non-low-delay application, encoding and decoding schemes are set to H264, and the network path is set to a bandwidth path of 20 Mbps. On the other hand, in a case where the robot 32 is in operation, it is assumed that the application is a low-delay application, encoding and decoding schemes are uncompressed schemes, and the network path is set to a wavelength path.

The controller 94 obtains the application status of the robot 32. This timing is determined according to the application of the robot 32, and may be periodic or may be at the time of transmission of the video signal.

When the controller 94 receives notification from the robot 32 that it is stopped, it performs the following control according to the description in the rule table.
Connect the video MC 10 at the base C and the video MC 10 at the base A with a bandwidth path of 20 Mbps.
Connect the allocation unit 13 and the optical selector 15 provided in the video MC 10 at the base C to the H264 encoder 14B, and cause the encoder 95 to execute the H264 encoder 14B.
Connect the optical selector 25 and the selector 23 provided in the video MC 10 at the base C to the H264 decoder 24B, and cause the decoder 96 to execute the H264 decoder 24B.

When the controller 94 receives notification from the robot 32 that it is in operation, it performs the following control according to the description in the rule table.
Connect the video MC 10 at the base C and the video MC 10 at the base A with a wavelength path.
Connect the allocation unit 13 and the optical selector 15 provided in the video MC 10 at the base C to the optical modulator 14A, and cause the encoder 95 to execute the uncompressed optical modulation.
Connect the optical selector 25 and the selector 23 provided in the video MC 10 at the base A to the optical demodulator 24A, and cause it to execute the uncompressed optical demodulation.

The video MC 10 at the base A demodulates the optical signal received from the video MC 10 at the base C into an electrical signal by the decoder 24 and outputs the electrical signal from the HDMI output IF 22. Thus, the video signal generated by the video signal source 91 is displayed on the monitor 92 arranged at the base A.

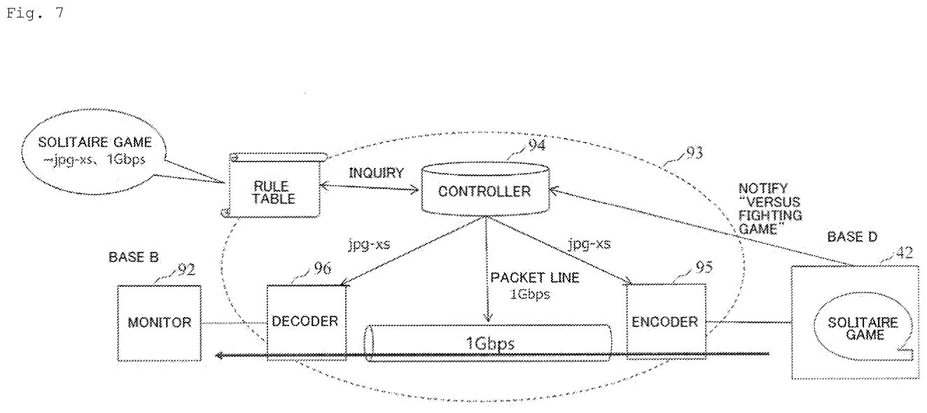

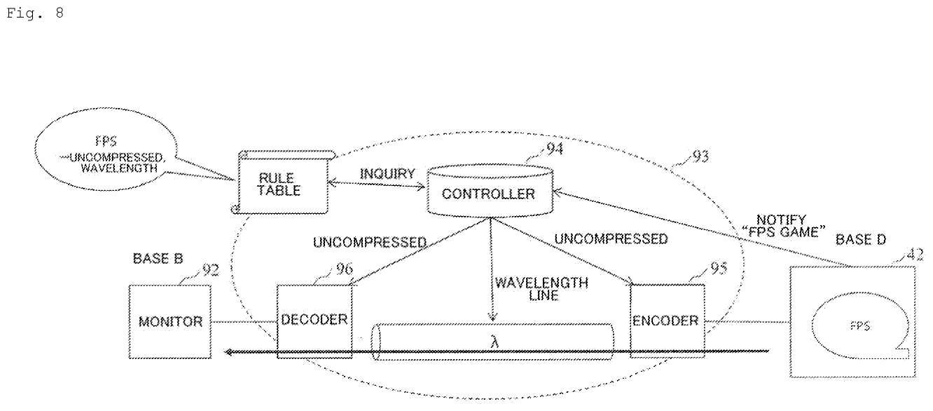

An example of system operation when displaying a video from the game machine 42 at the base D on the monitor 92 at the base B will be described with reference to FIGS. 7 and 8. FIG. 7 shows a case where the application is a solitaire game, and FIG. 8 shows a case where the application is an FPS game. In the rule table, as shown in FIG. 4, in a case where it is the solitaire game, encoding and decoding schemes are set to JPEG-XS, and the network path is set to a network path of 1 Gbps.

On the other hand, in a case where it is the FPS game, encoding and decoding schemes are uncompressed schemes, and the network path is set to a wavelength path.

When the controller 94 receives notification that it is the solitaire game as the application status, it performs the following control according to the description in the rule table.
Connect the video MC 10 at the base D and the video MC 10 at the base B with a network path of 1 Gbps.
Connect the allocation unit 13 and the optical selector 15 provided in the video MC 10 at the base D to the JPEG-XS encoder 14C, and cause the encoder 95 to execute the JPEG-XS encoder 14C.
Connect the optical selector 25 and the selector 23 provided in the video MC 10 at the base B to the JPEG-XS decoder 24C, and cause the decoder 96 to execute the JPEG-XS decoder 24C.

When the controller 94 receives notification that it is the FPS game as the application status, it performs the following control according to the description in the rule table.
Connect the video MC 10 at the base D and the video MC 10 at the base B with a wavelength path.
Connect the allocation unit 13 and the optical selector 15 provided in the video MC 10 at the base D to the optical modulator 14A, and cause the encoder 95 to execute the uncompressed optical modulation.
Connect the optical selector 25 and the selector 23 provided in the video MC 10 at the base A to the optical demodulator 24A, and cause the decoder 96 to execute the optical demodulator 24A.

The video MC 10 at the base B demodulates the optical signal received from the video MC 10 at the base D into an electrical signal by the decoder 24 and outputs the electrical signal from the HDMI output IF 22. Thus, the video signal is displayed on the monitor 92 arranged at the base B.

As described above, the present embodiment enables the operation that the encoding bandwidth becomes larger with priority given to the low delay side, and also low-delay video transmission in applications requiring video transmission with low delay even when the data transmission network 93 is congested.

### Second Embodiment

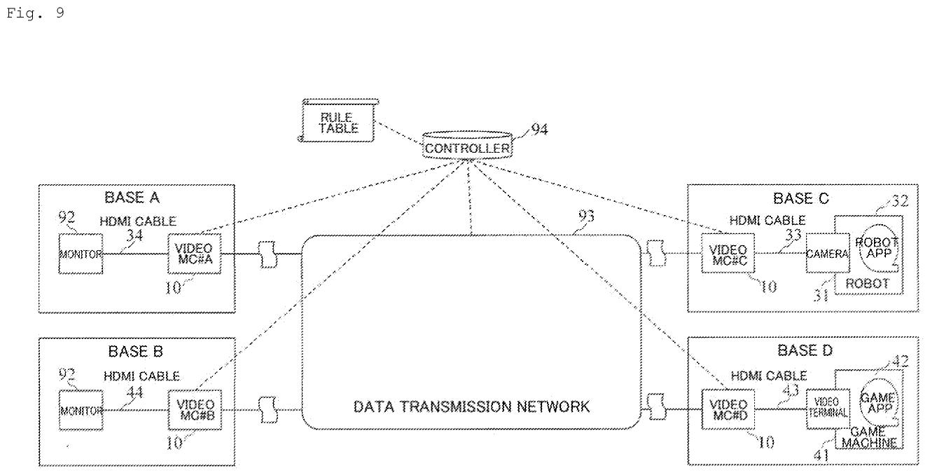

FIG. 9 illustrates a configuration example of a system according to the present embodiment. The video transmission system according to the present embodiment analyzes the video transmitted within the data transmission network 93 to estimate the application status, and sets the encoder 95 and decoder 96, and the network path for transmission based on the estimation result.

In the case of the robot 32, it is controlled by the application status of the robot 32 (stopping or moving).

In the case of the game machine 42, it is controlled according to the type of game.

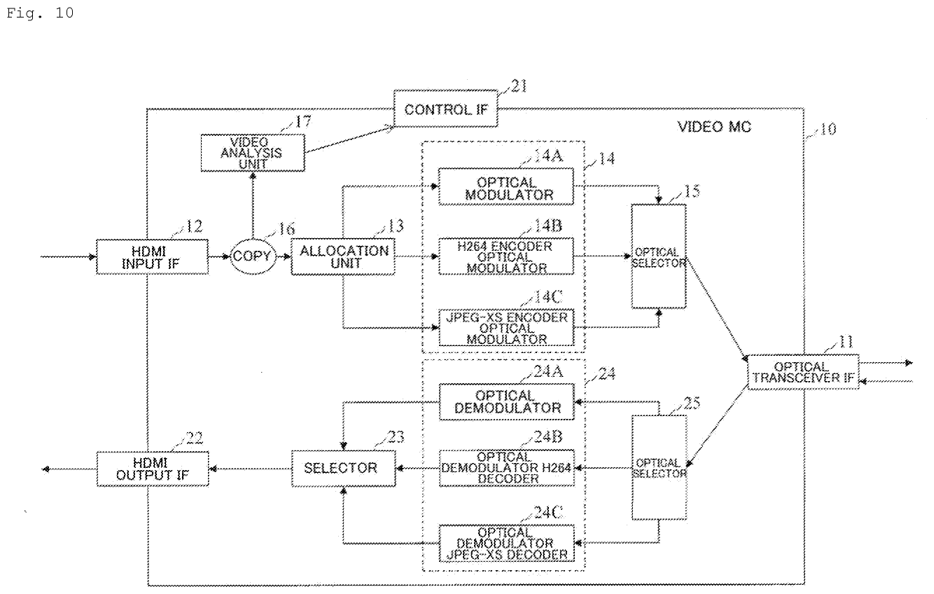

FIG. 10 shows a configuration example of the video MC 10 of this embodiment. In the present embodiment, the video MC 10 includes a duplication unit 16 and a video analysis unit 17. The duplication unit 16 duplicates the video signal, and the video analysis unit 17 performs video analysis. The control IF 21 notifies the analysis result of the video analysis unit 17 to the controller 94. The controller 94 refers to the rule table and provides necessary network paths (bandwidth path or wavelength path) within the data transmission network 93 while controlling the operation of the video MC 10 according to the description of the rule table.

The video analysis unit 17 performs analysis for identifying the application status defined in the rule table without limitations in analysis methods. For example, it is possible to set an input signal to the video signal and an output signal to the application status, train artificial intelligence (AI), and make an inference from the learning result. Alternatively, it may be determined from a feature value obtained by image processing a video signal such as the amount of motion in the video.

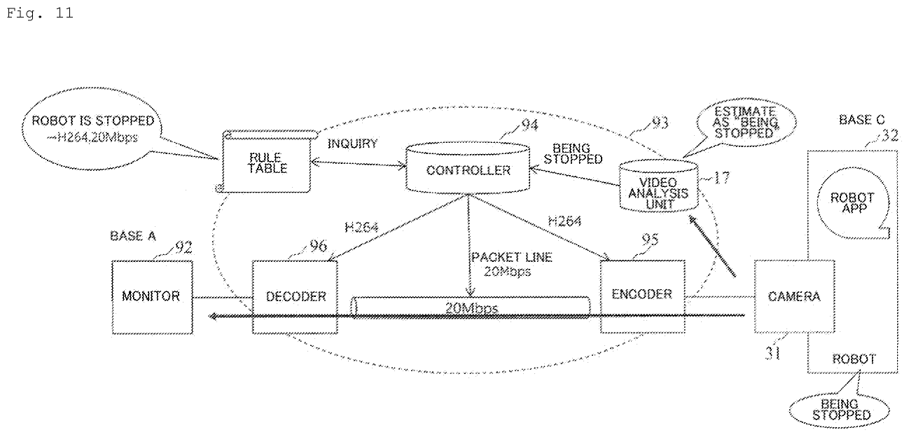

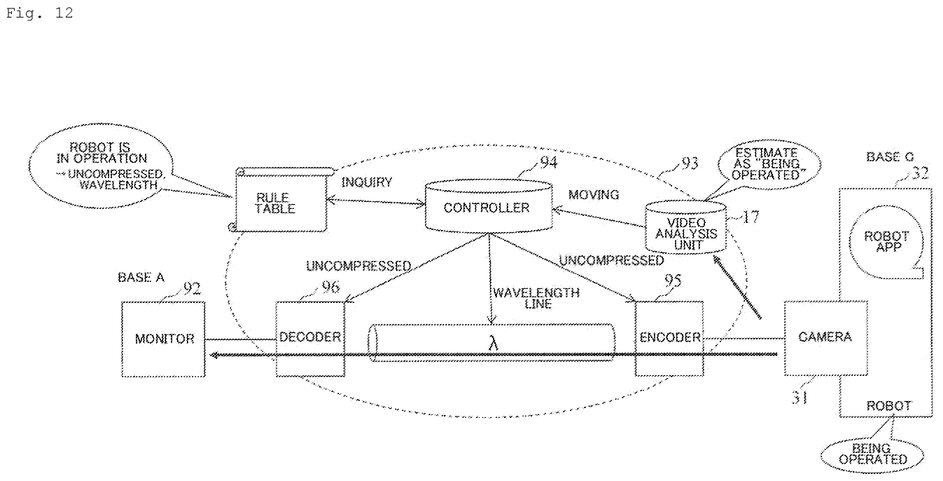

An example of system operation when displaying a video from the robot 32 at the base C on the monitor 92 at the base A will be described with reference to FIGS. 11 and 12. FIG. 11 shows a case where the application is stopped, and FIG. 12 shows a case where the application is in operation. The video analysis unit 17 provided in the video MC 10 at the base C estimates the application status of the robot 32 using the information input from the HDMI input IF 12.

In a case where the robot 32 is stopped, the control IF 21 notifies the controller 94 that the application status of the robot 32 is “being stopped.” Accordingly, as in the first embodiment, the controller 94 performs control when the robot 32 is stopped according to the description of the rule table.

In a case where the robot 32 is in operation, the control IF 21 notifies the controller 94 that the application status of the robot 32 is “being operated.” Accordingly, as in the first embodiment, the controller 94 performs control when the robot 32 is in operation according to the description of the rule table.

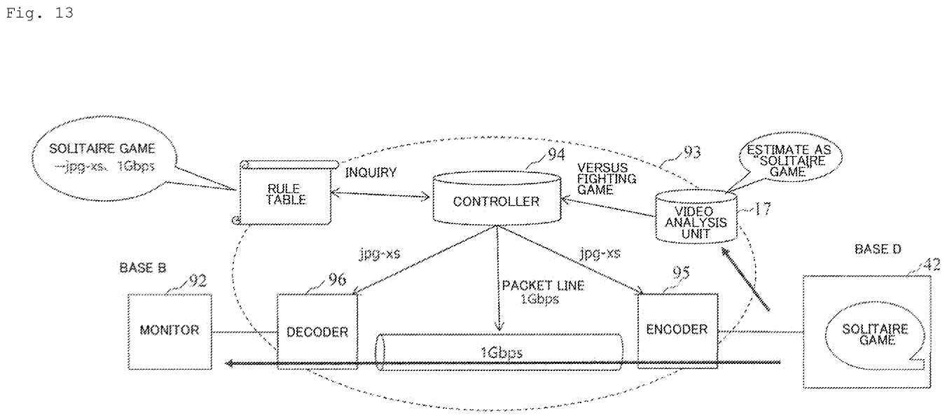

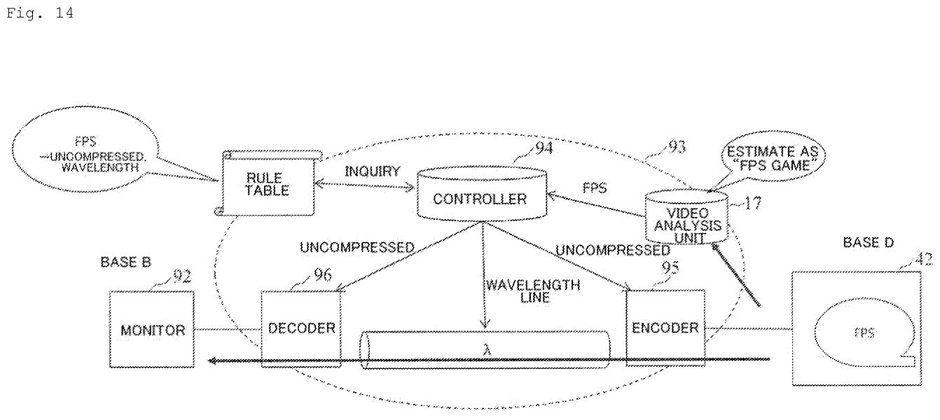

An example of system operation when displaying a video from the game machine 42 at the base D on the monitor 92 at the base B will be described with reference to FIGS. 13 and 14. FIG. 13 shows a case where the application is a solitaire game, and FIG. 14 shows a case where the application is an FPS game. The video analysis unit 17 provided in the video MC 10 at the base D estimates the type of the game running on the game machine 42 using the information input from the HDMI input IF 12.

In a case where the game type is a solitaire game, the control IF 21 notifies the controller 94 that it is a solitaire game. Accordingly, as in the first embodiment, the controller 94 performs control when the application status is a solitaire game according to the description of the rule table.

In a case where the game type is an FPS game, the control IF 21 notifies the controller 94 that it is an FPS game. Accordingly, as in the first embodiment, the controller 94 performs control when the application status is an FPS game according to the description of the rule table.

According to the present embodiment, since there is no need for notification from the video signal source 91 such as the robot 32 and the game machine 42, the system of the present disclosure can be applied to the video signal source 91 having any application. In the present embodiment, an example in which the video analysis unit 17 is provided in the video MC 10 is shown, but the video analysis unit 17 can be arranged in any device such as the controller 94.

### Third Embodiment

If video analysis and encoding selection are performed by the base-side video MC, the video MC 10 may be overloaded and the device may become larger. Therefore, in the present embodiment, the base-side MC simply performs uncompressed transmission, and the encoding selection is performed on the data transmission network 93.

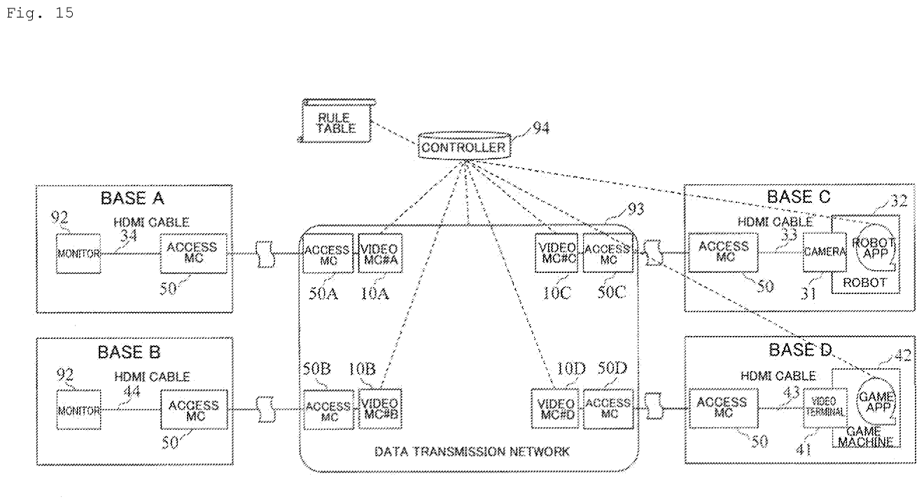

FIG. 15 illustrates a configuration example of a system according to the present embodiment. In the video transmission system according to the present embodiment, the video MC 10 is provided in the data transmission network 93, the monitors 92 arranged at the base A and the base B, the robot 32 arranged at the base C and the game machine 42 arranged at the base D are connected to the data transmission network 93 via an access MC 50 arranged at each base.

In the present embodiment, the data transmission network 93 is also provided with the access MC 50 for each base. In the present embodiment, the access MCs 50 provided for each base are described as 50A, 50B, 50C, and 50D. In the present embodiment, the video MC 10 is provided within the data transmission network 93. In the present embodiment, the video MCs 10 provided for each base are described as 10A, 10B, 10C, and 10D.

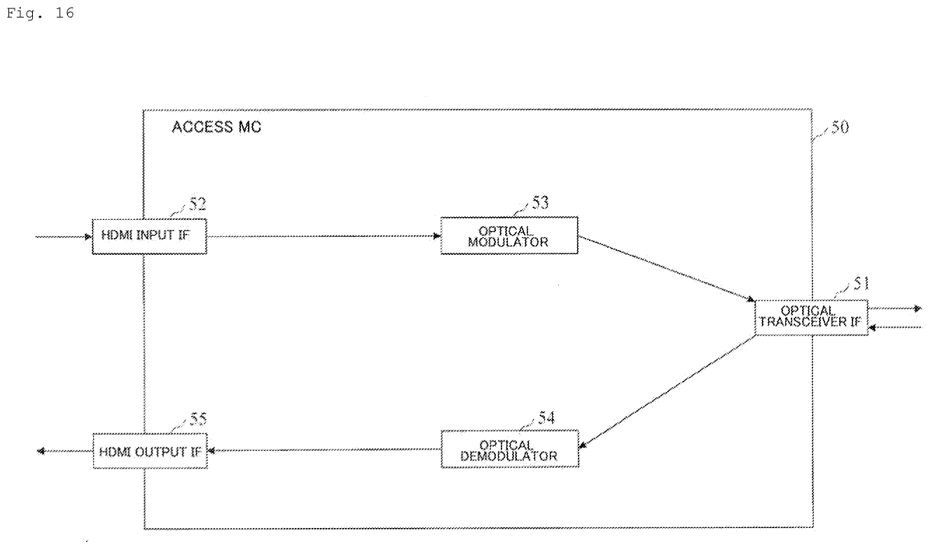

FIG. 16 shows a configuration example of the access MC 50. The access MC 50 includes an optical transceiver IF 51, an HDMI input IF 52, an optical modulator 53, an optical demodulator 54, and an HDMI output IF 55.

In the case of the access MC 50C located at the base C, when a video signal is input to the HDMI input IF 52, the optical modulator 53 modulates the video signal into an optical signal without compression and outputs the optical signal from the optical transceiver IF 51. The output optical signal is input from the optical transceiver IF 51 provided in the access MC 50C, demodulated into an electrical signal by the optical demodulator 54, and output from the HDMI output IF 55. The video signal from the access MC 50C is input to the HDMI input IF 12 provided in the video MC10.

The controller 94 acquires the application status of the robot 32 from the robot 32 or the video MC 10A, as in the previous embodiment. The video MCs 10 #C and 10 #A are controlled according to the description in the rule table.

A video signal output from the video MC 10 #A is input to the HDMI input IF 52 of the access MC 50A. The optical modulator 53 of the access MC 50A modulates the video signal into an optical signal without compression and outputs it from the optical transceiver IF 51. The output optical signal is input from the optical transceiver IF 51 provided in the access MC 50 located at the base A. The access MC 50 located at the base A demodulates the optical signal into an electrical signal with the optical demodulator 54 and outputs the electrical signal from the HDMI output IF 55. Thus, the video signal is displayed on the monitor 92 arranged at the base A.

### (Effect of the Present Disclosure)

By controlling the video encoding scheme and the network path to be used according to the application status, it is possible to optimize the delay in video transmission while effectively utilizing the resources of the data transmission network. In addition to the application provided in the video signal source 91, any functions provided in the controller 94, the video MC 10, and the access MC 50 can also be implemented by a computer and a program, and the program can be recorded on a recording medium or provided through a network.

### INDUSTRIAL APPLICABILITY

The present disclosure is applicable to information and communication industries.

### REFERENCE SIGNS LIST

10, 10A, 10B, 10C, 10D: Video MC
11, 51: Optical transceiver IF
12, 52: HDMI input IF
13: Allocation unit
14: Encoder
15, 25: Optical selector
16: Duplication unit
17: Video analysis unit
21: Control IF
22, 55: HDMI output IF
23: Selection unit
24: Decoder
31: Camera
32: Robot
33, 34, 43, 44: HDMI cable
41: Video terminal
42: Game machine
50, 50A, 50B, 50C, 50D: Access MC
53: Optical modulator
54: Optical demodulator
91: Video signal source
92: Monitor
93: Data transmission network
94: Controller
95: Encoder
96: Decoder

1. A device which acquires a status of an application using video transmission;
selects an encoding scheme and a decoding scheme of a video signal generated by the application according to the status of the application; and
secures resources of a data transmission network that transmits the video signal according to the selection result.

2. The device according to claim 1, wherein resources of the data transmission network allocated to low-delay applications are larger than resources of the data transmission network allocated to non-low-delay applications.

3. The device according to claim 1, wherein,
in a case of low-delay applications, uncompressed or low-compression encoding and decoding schemes are selected, and
in a case of non-low-delay applications, high-compression encoding and decoding schemes are selected.

4. The device according to claim 1, wherein the status of the application is acquired by analyzing a video signal generated by the application.

5. A non-transitory computer-readable medium having computer-executable instructions that, upon execution of the instructions by a processor of a computer, cause the computer to function as the device according to claim 1.

6. A method, comprising:
acquiring a status of an application using video transmission;
selecting an encoding scheme and a decoding scheme of a video signal generated by the application according to the status of the application; and
securing resources of a data transmission network that transmits the video signal according to the selection result.

7. A system comprising:
a video signal source that executes an application that uses video transmission;
a data transmission network that transmits a video signal generated by the application; and
a controller that controls resources of the data transmission network,
wherein the controller is configured to:
acquire a status of the application from the video signal source;
select an encoding scheme and a decoding scheme of a video signal generated by the application according to the acquired status of the application; and
secure resources of a data transmission network according to the selection result.

8. The system according to claim 7, further comprising:
a transmission-side media converter (MC) that converts the video signal from the video signal source into a format that can be transmitted over the data transmission network; and
a receiver-side MC that converts the video signal transmitted over the data transmission network into a video signal from the video signal source,
wherein the controller is configured to select, according to the status of the application, an encoding scheme for conversion into a format that can be transmitted over the data transmission network in the transmission-side MC, and a decoding scheme for converting into the video signal from the video signal source in the receiver-side MC,
the transmission-side MC encodes the video signal from the video signal source using the encoding scheme selected by the controller, and
the receiver-side MC decodes the video signal transmitted over the data transmission
network using the decoding scheme selected by the controller.
